(19) United States
(12) Patent Application Publication
(10) Pub. No.: US 2007/0024776 A1
(43) Pub. Date: Feb. 1, 2007

(54) Integrated polarizer/optical film with a wire grid structure and a manufacturing method thereof

(76) Inventors: Yue-Shih Jeng, Miao Li Hsien (TW); Yuh-Shyang Chen, Taipei City (TW); Wei-Chih Liu, Tai Chung City (TW); Tsung-Hsiung Wang, Ta Li City (TW); Yu-Hsun Wu, Chung Li City (TW); Wei-Yi Chien, Chi Lung City (TW)

Correspondence Address: RABIN & BERDO, P.C., Suite 500, 1101 14 Street, N.W., Washington, DC, 20005, US

(21) Appl. No.: 11/312,933

(22) Filed: Dec. 21, 2005

(30) Foreign Application Priority Data
Jul. 29, 2005 (TW) 94125886

(51) Int. Cl. G02F 1/1335

(52) U.S. Cl. 349/113

(57) ABSTRACT

An integrated type optical film with a wire grid polarizer structure and a manufacturing method thereof solves the optical matching problem of conventional optical film and integrates an optical effectiveness with all layers by using non-linear optical theory to redistribute integral polarizing efficiency and transmittance in all layers. The integrated type optical film includes two types of polarizers, a reflective type wire grid polarizer and an absorbing type polarizer. The reflective type wire grid polarizer can reflect an incident polarizing light parallel with a metal grid thereof, and transform and transmit polarizing light perpendicular to the polarizer with secondary transmitting efficiency, so that multi-layered structures are integrated into a polarizer with high polarizing efficiency, high transmittance and light-reflective efficiency.

### BACKGROUND OF THE INVENTION

1. Field of the Invention

The present invention relates to an integrated polarizer/optical film with a wire grid structure and a manufacturing method thereof, and more particularly, to an integrated polarizer/optical film structure that can both reflect and absorb light. The polarizer/optical film structure utilizes nonlinear optical theory to redistribute integral polarizing efficiency and transmittance to all layers of the polarizer/optical film structure and a manufacturing method thereof.

2. Description of Related Art

Currently, polarizer/optical film is applied to all kinds of goods, for example, polarizing film, wide-viewing angle film or brightness enhancement film for display screens. It can also used for polarizing optical microscopes, sunglasses, objects used to create shade, display screens, and lighting.

Liquid crystal displays (hereinafter referred to as LCDs) need polarizer/optical film. LCDs use two-pieces of polarizing film to produce a linearly polarized light to create contrast. A backlight module of the LCD provides a primary light. The primary light follows the liquid crystal and is twisted to generate linearly polarized light when the primary light passes through a first polarization film. When the linearly polarized light has passed through a second polarization, it generates contrast.

Commercial polarizers use dichroic liquid. Polymer (for example, PVA, polyvinylacetate or polyvinyl alcohol) is the base for dichroic liquid. The polarizer absorbs dichroic liquid (such as iodine or dye) so that the iodine ions or dye ions extend into the inside of the dichroic liquid/polymer. After the polarizer is heated it is stretched so that it becomes a PVA membrane. To reach the best point for viewing, light penetration must be less than 5% of the original light passing through the film. The other 95% if the light is either refracted, reflected or absorbed by the layers of film. The absorption rate and the transmittance of the dichroic polarizer are two factors that affect the brightness of an LCD. The polarizing film determines the contrast and viewing angle of the LCD. Therefore, how to enhancing the lighting source and adding light transmittance are vital problems that need to be overcome in LCD technology.

At present, there are two main methods for increasing the overall light transmittance level: (1) by increasing the transmittance of an incident light; and (2) by increasing the light intensity of a backlight module. The first method improves the transmittance of a polarizer, or changes the polarization mode of an incident light before the incident light enters the polarizer, so that the polarization mode of the incident light is parallel to the polarization of the polarizer, thus enhancing the transmittance of the incident light. At present, the transmittance of the current iodine polarizers is up to 44% to 46%, and has approached a level that makes further improvement of the light transmittance level difficult. This method changes the polarization mode of incident light to make the incident light travel parallel to the polarizer. Thereby, a high light transmittance is matched with an enhanced brightness film produced by a DBEF (by the 3M Company) and the reflective polarizer of a cholesterol liquid crystal. The second method increases the intensity of the incident light of a backlight source or achieves a 100% polarized light transmittance via direct polarization of the backlight source. In summation of the description above, the polarizer determines the contrast, viewing angle and light transmittance level of the display. Increasing the light transmittance level of polarizers is an important developmental trend for polarizers in the future.

There are two types of brightness enhancement film—cholesterol liquid crystal reflective and DBEF multi-film reflective. The principle of brightness enhancement film uses non-polarization visible light to separate two mutual vertical polarizations of light. When the two separate vertical polarizations of light contact the film, one will be reflected. The other will pass through the film and continue traveling in the same direction.

There are two types of LCD polarizing film—O type and E type. Commercial polarizers typically use O iodine as the predominant liquid; its principle merit is its high polarizing efficiency (99.9%) and transmittance (44%-46%). The main disadvantages of O iodine polarizers are as follows: (1) O iodine polarizers have acute light loss in wide viewing situations, so O iodine polarizers need to be matched with a wide-viewing angle film to achieve high contrast; (2) O iodine polarizers do not work well in conditions with high temperatures or high humidity; (3) the polarizer mechanical properties of O iodine are not strong, so O iodine polarizers must have a protective film pasted onto it to strengthen its outside surface; (4) O iodine polarizers can only be pasted onto the outside of a monitor. E polarizing film mainly uses dichroic liquid crystals to absorb light when light is passed through the E polarizing film. While O polarization light is absorbed, E polarization light can pass through the polarizing film, thereby attaining linearly polarized light. The best optical effect of E polarizing film at present is approximately 95% efficiency while transmittance is between 40%-44%. The advantages of E polarizing film are: (1) its thickness is approximately only 0.3-0.8 micrometers; (2) it is produced in a liquid crystal cell. Referring to the table below shows the characteristics of O type polarizing film and E type polarizing film.

TABLE 1
the characteristics of O type polarizing film and E type polarizing
film.

| | Iodine (O type) | Optiva (E type) | Dye (O type) |
|---|---|---|---|
| Polarizing | Best (99.8%) | Good (95%) | Good (94.5%) |
| efficiency | | | |
| Transmittance | Best (44%) | Good (44%) | Nice (30%) |
| Thickness | About 200 nm | Best (about 0.8 mm) | About 2.6 mm) |
| Cell | Outside | Inside/outside | Inside/outside |
| inside/outside | | | |
| Wide viewing | light loss in wide | Light loss in narrow | Light loss in |
| angle | viewing, | viewing | wide viewing |
| Contrast | High | Common | Common |
| Reflective | No | No | No |
| light | | | |

At present iodine series polarizer technology of the prior art can be found in U.S. Pat. No. 4,591,512 that discloses a method for making visible range dichroic polarizer material comprising of a uniaxially stretched film of polyvinyl alcohol stained with iodine and treated with a borating solution containing zinc salt. The mechanical properties, the temperature and humidity of the polarizer are poor. Moreover, the body of iodine polarizing film is coated with a protective film of triacetyl cellulose (TAC) on the upper and lower sides. Thereby, the present iodine series polarizing film thickness is approximately 200 micrometers. E type polarizer technology prior art can be found in a number of applications, for example, U.S. Pat. Nos. 6,583,284, 6,563,640, 6,174,394, 6,049,428, and 5,739,296. The above technology coats polarizing film with discotic liquid crystal to create an absorbent surface on the substrate. After it has dried, the polarizing film becomes E type polarizing film. Light is produced by E type polarized light when it passes through E type polarizing film.

Another type of polarizing film is O type polarizing film. O type polarizing film coats a dye on the surface of the substrate to form polarizing film. O type polarizer technology of the prior art can be found U.S. Pat. Nos. 5,812,264, 6,007,745, 5,601,884 and 5,743,980.

In contrast to the iodine series and E type polarizing film, another type of coated polarizing film is dye series polarizing film which is mainly an absorption carrier. The influence absorbency parameters of dye series polarizing film are: (1) its absorption coefficient of dye molecules; (2) its increased dye density and (3) its polarizing film thickness. The main advantages of the dye series polarizing film are: (1) it operates well under high temperatures and humid conditions; (2) there are a number of methods that may be used to coat the film, such as spin coating, die coating and dip coating and (3) it is produced in a liquid crystal cell. The main disadvantages of the dye series polarizers are as follows: (1) obtaining high absorption dye is difficult, (2) to create high polarizing efficiency requires high consistency dye and (3) the thinness of the film reduces transmittance and limits the application dye series polarizing film.

The wire grid polarizer can also be used as a reflective polarizing film. Wire grid polarizers were developed over a hundred years ago and the principle of polarizered light and reflectivity is described as follows: non-polarization incidence light enters the wire grid polarizing film formed by a pair of parallel wires. Polarization light that is parallel to the wire grid is reflected while polarization light that is vertical to the wire grid passes through the grid. Non-polarized light is separated into two-way mutual vertical polarization lights these reflecting and passing manners. As such, we can say that wire polarizing film can both polarize and reflect light simultaneously. Wire grid polarizer technology of the prior art can be found in, for example, U.S. Pat. Nos. 5,986,730, 6,108,131, 6,208,463, 6,122,103 and 6,447,120. The polarizing efficiency of the wire grid polarizer is about 99% and the transmittance of the wire grid polarizer is about 44.49%. Analysis of the light shows that the effect is better than the iodine series polarizing film. The non-polarization light source changes the polarization light after passing through the brightness enhancement film. It then passes through the polarizing film. So, the result is the same as that of the multi-layer polarizing film analysis. Therefore we find that two layers of polarizing film are worse than the optical match stack and while obtaining polarizing efficiency and contrast, transmittance is reduced. For example, the wire grid polarizer matches the iodine series polarizing film (with polarizing efficiency of 99.8% and transmittance of 44%), when the light passes through a brightness enhancement film and then passes through a polarizing film. The light passing efficiency of the wire grid polarizer is about 44.49% if we do not consider the second light passing efficiency of the reflective light. If the wire grid polarizer and the iodine series polarizing film have 44% to 46% transmittance when combined, the whole transmittance is reduced to about 40% to 41%. In terms of polarizing efficiency, the iodine series polarizing film is about 99.5%. Therefore it can be deduced that the wire grid polarizer contributes less towards the entire polarizing efficiency than the iodine series polarizing film.

In fact, a conventional polarizing film is matched with polarizing film to generate brightness and reduce transmittance. Then the second light passing through the iodine series polarizing film is used to increase transmittance. That is, the optical effect is poor because of the loss in light passing efficiency rate. Even if the reflective brightness is increased, 100% brightness is not achievable.

To sum up, the polarizing film for producing a polarization in the present LCDs does not itself come with a brightness enhancement; rather, the brightness-enhancing film provides the brightness enhancement. Most of the systems adopt a brightness-enhancing film attached to the polarizing film, but the systems do not combine with a polarizing film to produce the overall performance that is desired.

### SUMMARY OF THE INVENTION

For eliminating the defects of the prior art, the applicant proposes an integrated polarizer/optical film with a wire grid structure and a manufacturing method thereof.

Therefore, it is a primary object of the present invention to provide an integrated polarizer/optical film with a wire grid structure and a manufacturing method thereof, that primarily adopts a system of assembly model to overcome the overall poor match of optical effect of the traditional polarizer and brightness-enhancing film, causing an overall decrease in the light transmittance and having its polarization achieved only via the polarizing film. The present invention rearranges the polarization and light transmittance level of different films to produce an overall polarization and light transmittance level higher than those of the polarizer accompanied with the brightness-enhancing film. The present invention also reflects light and uses multi-layer polarizing film optics design to avoid the disadvantages of wide viewing angle brightness and full wavelength (400 nm to 700 nm) of the wire grid polarizer of conventional forms. The novel polarizing film of the present invention can fully obtain light transmittance the first and second time light contacts the film, without incurring any optical loss. The present invention simultaneously has the advantages of polarizing film and the wire grid polarizer.

The integrated polarizer/optical film with a wire grid structure of the present invention can be formed with a number of different structures. The functions of the present invention depend upon the selected materials and structure. Due to the design, polarization and light transmittance achieved by combining the polarizing film and the brightness-enhancing film, not only is polarization improved, but light transmittance is also enhanced.

For achieving the objects above, the present invention provides an integrated polarizer/optical film with a wire grid structure, comprising of a first portion and a second portion. The first portion is a wire grid reflective type polarizer and the second portion is an absorbing polarizer/optical film and formed on the first portion. The absorbing polarizer is an O type dye polarizer or an E type polarizer.

For achieving the objects above, the present invention in accordance with another embodiment further provides a least one o substrate and an integrated polarizer/optical film, made of a different material from that of the substrate, on top of the substrate. Such material includes two portions, a wire grid reflective polarized film and an absorbing polarizer, wherein the absorbing polarizer is an O type dye polarizer or an E type polarizer.

For achieving the objects above, the present invention provides a method for manufacturing an integrated polarizer/optical film structure, comprising of the steps of providing at least one substrate and forming at least one layer of an integrated polarizer/optical film, made of a material different from that of the substrate, on top of the substrate. Such material includes two portions, a wire grid reflective type polarized film and an absorbing polarizer, wherein the absorbing polarizer is an O type dye polarizer or an E type polarizer.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is an integrated polarizer/optical film that sits on one side of a substrate;

FIG. 2 is a reflective wire grid polarizer/optical film sits on one side of the substrate;

FIG. 3 is a multi-layered film embodiment schematic drawing in accordance with the present invention;

FIG. 4A adds an absorbing polarizer/optical film on the integrated polarizer/optical film and adds a reflective type wire grid polarizer/optical film to one side of the substrate;

FIG. 4B is a drawing of two sides of the substrate sitting on top of the integrated polarizer/optical film 22 individually;

FIG. 5A is an embodiment schematic drawing of an integrated polarizer/optical film applied for two-substrates in accordance with the present invention;

FIG. 5B is another embodiment in accordance with FIG. 5A of the present invention;

FIG. 5C is a third embodiment in accordance with FIG. 5A of the present invention;

FIG. 5D is a forth embodiment in accordance with FIG. 5A of the present invention;

FIG. 5E is an embodiment of two substrates applied with different materials in accordance with the present invention;

FIG. 5F is a second embodiment of two substrates applied with different materials in accordance with the present invention;

FIG. 5G is a third embodiment of two substrates applied with different materials in accordance with the present invention;

FIG. 5H is a forth embodiment of two substrates applied with different materials in accordance with the present invention;

FIG. 5I is a fifth embodiment of two substrates applied with different materials in accordance with the present invention;

FIG. 5J is a first embodiment of an integrated polarizer/optical film applied with two substrates and a part sitting on two sides of the substrate in accordance with the present invention;

FIG. 5K is a second embodiment of an integrated polarizer/optical film applied with two substrates and integrated polarizer/optical films sitting on two sides of the substrate in accordance with the present invention;

FIG. 5L is a third embodiment of an integrated polarizer/optical film applied with two substrates and integrated polarizer/optical films sitting on two sides of the substrate in accordance with the present invention;

FIG. 6 is a structure for the integrated type wire grid polarizer/optical film structure of the present invention;

FIG. 7A is a polarizing efficiency curve and the transmittance curve of different wavelengths relative to the second layer (absorbing layer);

FIG. 7B is a polarizing efficiency curve and the transmittance curve of different wavelengths relative to the first layer (wire grid layer);

FIG. 7C is a polarizing efficiency curve and the transmittance curve of different wavelengths relative to the after integrated polarizer;

FIG. 8A is a cross-section drawing of the transmittance rate of the integrated type polarizer at a 45 degree angle; and

FIG. 8B is a cross-section drawing of the transmittance rate of an integrated type polarizer at a 315-degree angle.

### DETAILED DESCRIPTION OF PREFERRED EMBODIMENTS

The above and other objects, features, and advantages of the present invention will become apparent from the following detailed description taken in accordance with the accompanying drawings. However, the drawings are provided for reference and illustration, and are not intended to limit the present invention.

If light passes through two polarizers stacked on top of each other, the total thickness of the polarizers is greater than the thickness of a single polarizer, and therefore increases the light transmitting thickness. Although such an arrangement increases absorbability and polarization, it suffers a significant loss of light transmission. In addition to the basic film problems, the two stacked polarizers also have an optical axis alignment problem. If the polarized light produced by a first polarizer enters a second polarizer, some portion of the light intensity is absorbed due to the deviation angle of the optic axis alignment. The light transmission level will thus drop. Although the two combined polarizers can increase the degree of polarization, the precious light transmission level is sacrificed as a tradeoff, and such a tradeoff is undoubtedly a major disadvantage for the display industry.

According to optical theory, the polarizing efficiency and the transmittance is a reversal reaction. If the polarizing efficiency is increased then the transmittance is reduced and vice versa. The polarizing efficiency and the transmittance equation is:

$$\begin{matrix}{E}_{P} = \frac{( T 0 - T 90 )}{( T 0 + T 90 )} & ( 1 ) \\ T = \frac{( T 0 + T 90 )}{2} & ( 2 )\end{matrix}$$

In the equation (1), Ep is a polarizing efficiency value; T0 is a transmission with polarization parallel to the transmission axis; and T90 is a transmission with polarization perpendicular to the transmission axis. In the equation (2), T is transmittance. The polarizing efficiency and the transmittance of the integrated polarizer/optical film structure are obtained through a combination of a non-linear optically design. The polarizing efficiency and the transmittance of the whole polarizer cannot be obtained through a linear optically design using equation (1) or equation (2) individually.

The present invention uses non-linear optically design to integrate two low polarizer/optical films to a signal polarizer/optical film with high polarization and high transmittance simultaneously. The present invention of the polarizing efficiency and the transmittance shows through by a nonlinear optics design and is redistributed between each layer of the film. In fact, the polarizing efficiency and transmittance of the integrated polarizer/optical film is decided by the entire film.

The present invention provides a method for manufacturing an integrated polarizer/optical film structure, comprising the steps of providing at least one substrate and forming at least one layer of an integrated polarizer/optical film made of a material different from that of the substrate on top of the substrate. Such material includes two portions—a wire grid reflective/polarized film and an absorbing polarizer, wherein the absorbing polarizer is an O type dye polarizer or an E type polarizer.

The invention whole polarizer comprises an absorbing polarizer and a reflective/polarized film, wherein the wire grid reflective/polarized film generates a reflective source. The polarized film of the present invention enhances reflectiveness and brightness when simultaneously providing polarizing efficiency and transmittance. Compared with brightness enhancement film that provides the same light brightness enhancement intensity, the present invention allows more light to pass through.

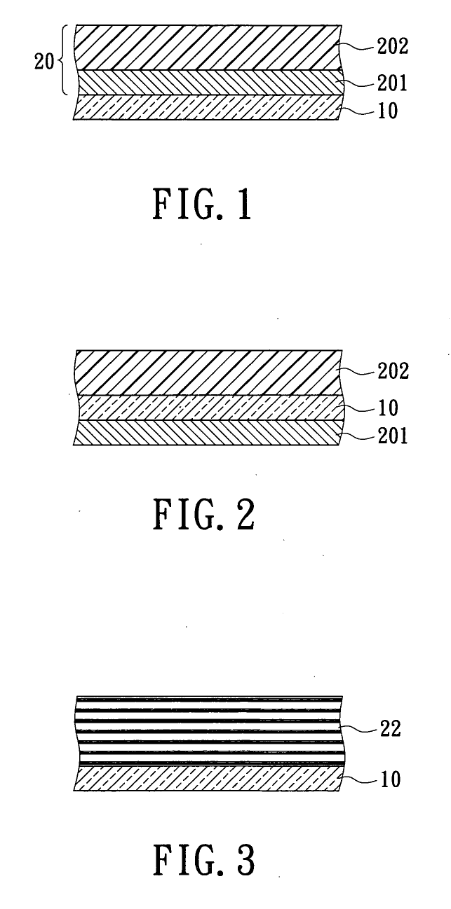

FIG. 1 and FIG. 2 show an integrated polarizer/optical film schematic drawing illustrating different embodiments when applying a single substrate in accordance with the present invention. FIG. 1 shows an integrated polarizer/optical film 20 sitting upon one side of a substrate 10. The integrated polarizer/optical film 20 comprises two portions. The first portion is a reflective type wire grid polarizer/optical film 201. The second portion is an absorbing type polarizer/optical film 202 using the non-linear optically manner and integrated into the first portion. The substrate 10 is a transmission substrate or a non-transmission substrate. The substrate 10 may consist of polymer material.

FIG. 1 shows a basic system of the present invention. In the present invention, the polarizing efficiency and transmittance of the integrated polarizer/optical film are decided by the combination of films. As such, apart from the basic structure as shown FIG. 1, the inside and the outside of the LCD have different structural combinations and multi-layered film structures. The polarized light is composed of various kinds of dye-type material layers, such as 0-type film, E-type film, P-type film, S-type film and any combination of the above films.

FIG. 2 shows the reflective wire grid polarizer/optical film 201 sitting upon one side of the substrate 10. The absorbing polarizer 202 sits upon another side of the substrate 10 using a non-linear optically manner. The absorbing polarizer 202 may be an O type dye series polarizer or an E type polarizer. The combination type of the integrated polarizer/optical film can be a P+O type, a P+E type, an S+O type, an S+E type, a left-hand light+an O type, a right-hand light+an O type, a left-hand light+an E type, or a right-hand light+an E type.

FIG. 3 shows a multi-layered film embodiment schematic drawing in accordance with the present invention. FIG. 3 shows the multi-layered film of the integrated polarizer/optical film 22 is sitting on the same side of the substrate 10. The integrated polarizer/optical film 22 uses the same or a different dye material that is patterned via a coating manner. There is a multi-layered film is disposed between the substrate 10 and the reflective wire grid polarizer/optical film 201, or the absorbing polarizer 202. This structure forms the integrated polarizer/optical film having a multi-layered film.

In addition, although the design of the polarizing efficiency and transmittance has a fixed value, between the combinations of films there are various changes that can be made due to different environments and materials. The polarizing efficiency and transmittance of the integrated polarizer/optical film is designed with a nonlinear optical theory and different combinations. When the films are superimposed, the films not only eliminate the need for transmittance but also enhance the entire polarizing efficiency.

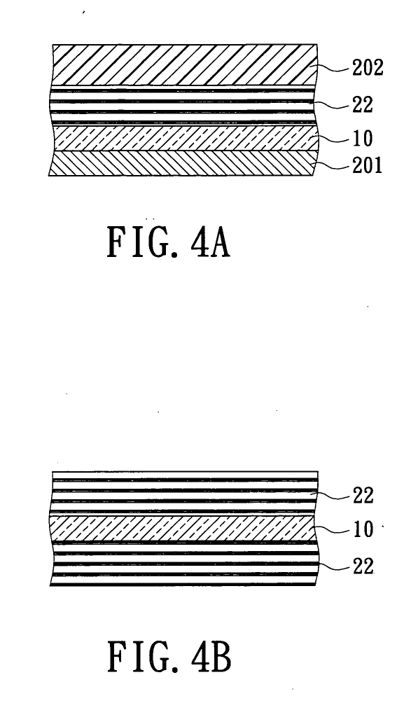

FIGS. 4A to 4B further show the addition of a multi-layered film based on FIG. 3 in accordance with the present invention. FIG. 4A shows the further addition of an absorbing polarizer/optical film 202 on the integrated polarizer/optical film 22 and the addition of a reflective type wire grid polarizer/optical film 201 to one side of the substrate 10. The reflective type wire grid polarizer/optical film 201 faces the integrated polarizer/optical film 22. FIG. 4B shows two sides of the substrate 10 sitting upon the integrated polarizer/optical film 22.

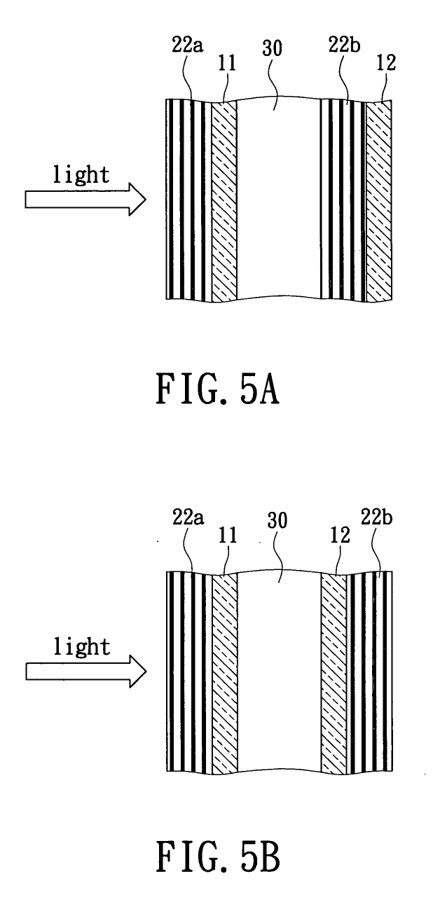

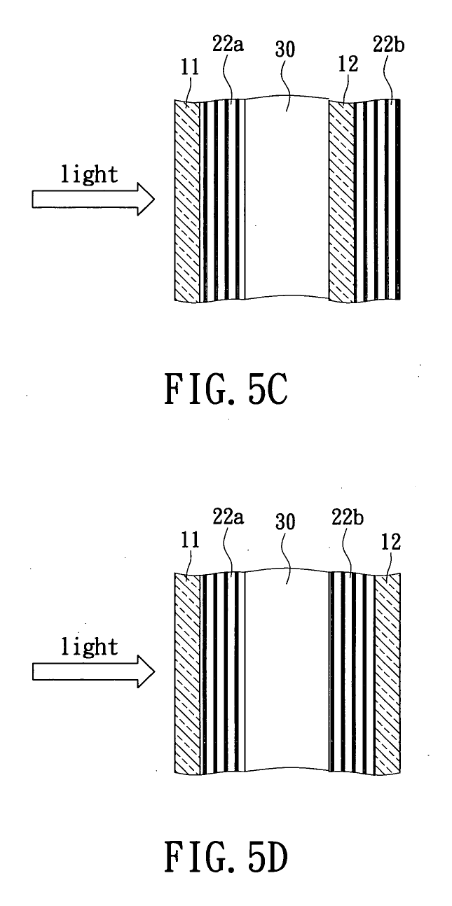

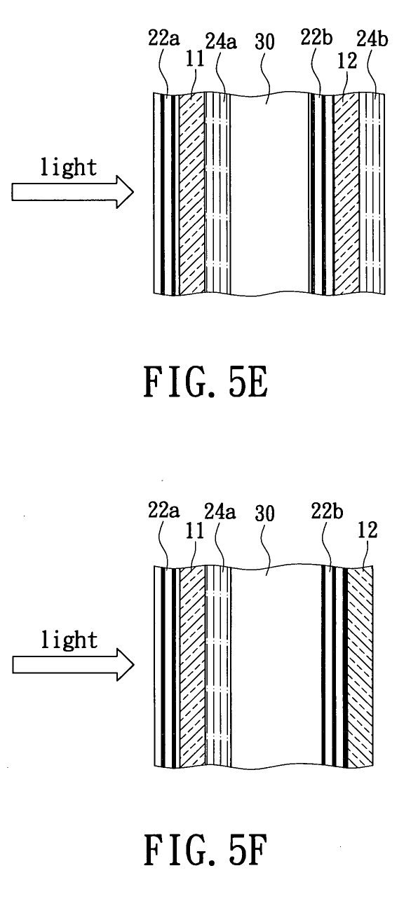

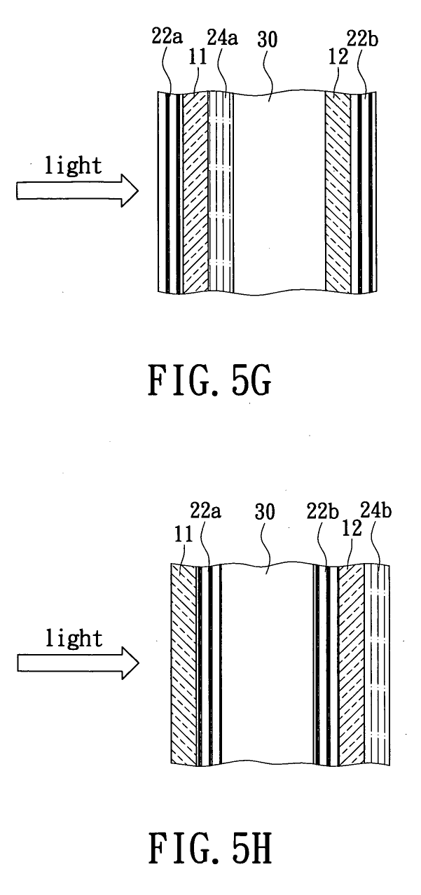

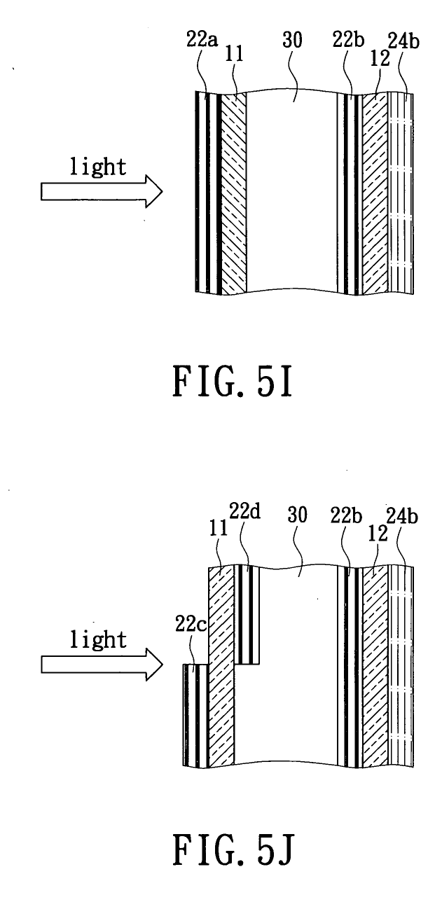

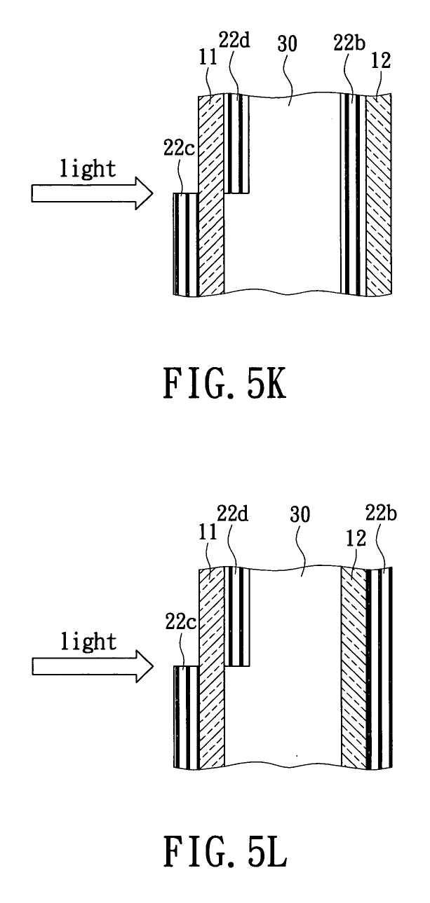

FIGS. 5A to 5L show a multi-layered film applied to a monitor in accordance with the present invention. The integrated polarizer/optical film of the present invention has various combinations. The present invention's structure is not only applicable as a polarizer, a wide viewing film or an optical film. Two layers of the polarizer film of the present invention can also be combined arbitrarily with a display screen during its manufacture.

FIG. 5A shows an integrated polarizer/optical film applied to two substrate embodiment schematic drawings in accordance with the present invention. The embodiment has two substrates. However, the present invention can use several substrates and is not limited to two substrates. The embodiment comprises a first substrate 11 and a second substrate 12 arranged in parallel. A plurality of fluid media 30 is filled into the space between the first substrate 11 and the second substrate. The cross light source on one side of the first substrate 11 sits upon a multi-layered film of the integrated polarizer/optical film 22a. The cross light source on one side of the second substrate 12 sits upon a multi-layered film of the integrated polarizer/optical film 22b. The plurality of fluid media 30 may be liquid crystal, an electrophoretic substance, a self-luminous object, or an easily displaying fluid medium.

FIG. 5B shows another embodiment in accordance with FIG. 5A of the present invention. In this embodiment, another side of the first substrate 11 has a plurality of fluid media 30 sitting upon the multi-layered film of integrated polarizer/optical film 22a. Another side of the second substrate 12 has the plurality of fluid media 30 sits upon the multi-layered film of integrated polarizer/optical film 22b.

FIG. 5C shows third embodiment in accordance with the FIG. 5A of the present invention. In this embodiment, the far side of the light source of the first substrate 11 and the second substrate 12 are sitting upon the integrated polarizer/optical film 22a and 22b individually.

FIG. 5D shows a forth embodiment in accordance with FIG. 5A of the present invention. In this embodiment, the cross side of the plurality of fluid media 30 of the first substrate 11 and the second substrate 12 sits upon the integrated polarizer/optical film 22a and 22b individually.

The combination of the integrated polarizer/optical film has various forms depending upon the use of different materials. FIG. 5E shows an embodiment using two substrates using different materials in accordance with the present invention. This embodiment comprises the first substrate 11, the second substrate 12 and the plurality of fluid media 30 filled in between. The cross side of the light source of the first substrate 11 sits upon the integrated polarizer/optical film 22a. The far side of the light source of second substrate 12 sits upon the integrated polarizer/optical film 24b. The integrated polarizer/optical film 22a and the integrated polarizer/optical film 24b are made of different materials.

FIG. 5F shows a second embodiment of two substrates applied for different materials in accordance with the present invention. In this embodiment, the cross side of the light source of the first substrate 11 sits upon the integrated polarizer/optical film 22a. The far side of the light source of the first substrate 12 sits upon the integrated polarizer/optical film 24a. The cross side of the light source of second substrate 12 sits upon the integrated polarizer/optical film 22b.

FIG. 5G shows a third embodiment of two substrates used for different materials in accordance with the present invention. In this embodiment, the cross side of the light source of the first substrate 11 sits upon the integrated polarizer/optical film 22a. The far side of the light source of the second substrate 12 sits upon the integrated polarizer/optical film 24a. The far side of the light source of second substrate 12 sits upon the integrated polarizer/optical film 22b.

FIG. 5H shows a forth embodiment of two substrates used for different materials in accordance with the present invention. In this embodiment, the far side of the light source of the first substrate 11 sits upon the integrated polarizer/optical film 22a. The cross side of the light source of the second substrate 12 sits upon the integrated polarizer/optical film 24a. The far side of the light source of second substrate 12 sits upon the integrated polarizer/optical film 22b.

FIG. 5I shows a fifth embodiment of two substrates used for different materials in accordance with the present invention. In this embodiment, the cross side of the light source of the first substrate 11 sits upon the integrated polarizer/optical film 22a. The cross side of the light source of the second substrate 12 sits upon the integrated polarizer/optical film 22b. The far side of the light source of second substrate 12 sits upon the integrated polarizer/optical film 24b.

The integrated polarizer/optical film of the present invention is disposed on two sides of the substrate. Thereby, it is possible to view the monitor from two sides. FIGS. 5J to 5L show an integrated polarizer/optical film applied with two substrates and a part between the two sides of the substrate in accordance with the present invention.

FIG. 5J shows a first embodiment of an integrated polarizer/optical film applied with two substrates disposed on two sides of the substrate in accordance with the present invention. This embodiment comprises the first substrate 11, the second substrate 12 and the plurality of fluid media 30 filled between thereof. The two sides of the first substrate 11 are disposed between the integrated polarizer/optical film 22c and 22d. The cross side of the light source of second substrate 12 sits upon the integrated polarizer/optical film 22b. The far side of the light source of second substrate 12 sits upon the integrated polarizer/optical film 24b. The integrated polarizer/optical film 22b and the integrated polarizer/optical film 24b are different materials (that are comprised of different absorbing polarizers that appear as cross-section lines in FIG. 5J).

FIG. 5K shows a second embodiment of an integrated polarizer/optical film applied with two substrates disposed on two sides of the substrate in accordance with the present invention. In this embodiment, the two sides of the first substrate 11 are disposed between the integrated polarizer/optical film 22c and 22d. The cross side of the light source of the second substrate 12 sits upon the integrated polarizer/optical film 22b.

FIG. 5L shows a third embodiment of an integrated polarizer/optical film applied with two substrates and disposed on two sides of the substrate in accordance with the present invention. In this embodiment, the two sides of the first substrate 11 are disposed between the integrated polarizer/optical film 22c and 22d. The far side of the light source of the second substrate 12 sits upon the integrated polarizer/optical film 24b.

These above described embodiments can be combined with the multi-layered polarizer design, and not only solves the problems of the wire grid polarizer but also use a coating manner to coat the inside of the cell. Furthermore, the present invention uses coating methods to allow different manufacturing methods to be achieved.

As one example, the reflective type polarizer is produced inside or outside of a liquid crystal cell. The absorbing type polarizer is produced inside a liquid crystal cell via a coating manner.

A second example is the absorbing type polarizer coated outside the liquid crystal cell via a coating manner and pasted on the reflective type polarizer.

A third example is the absorbing type polarizer coated on the reflective type polarizer via a coating manner and pasted on the liquid crystal cell.

A fourth example is the integrated polarizer/optical film produced outside of the liquid crystal cell and the absorbing type polarizer is a dye series polarizer/optical film or an E type polarizer/optical film. The absorbing type polarizer is coated outside the liquid crystal cell and pasted on the reflective polarizer/optical film, or the absorbing type polarizer/optical film is coated on the reflective type polarizer/optical film and then pasted on the liquid crystal cell.

The method of the present invention uses a coating method. The step of coating is achieved via a single slot-die coating method, an extrusion coating method, a Mayer rod coating method, or a blade coating method.

Also deserving mention is that the manufacturing method for the integrated type wire grid polarizer/optical film structure of the present invention that doesn't need to sit on the substrate comprises the steps of: forming at least one layer of a different material on the integrated type wire grid polarizer/optical film, wherein the different materials of the integrated type wire grid polarizer/optical film comprises two portions. The first portion is a wire grid reflective type polarizer. The second portion is an absorbing type polarizer/optical film that uses a non-linear optically manner to integrate the first portion. The absorption type polarizer is an O type dye series polarizer or an E type polarizer/optical film.

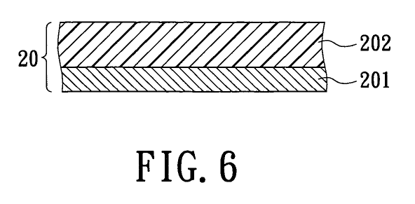

FIG. 6 shows a structure for the integrated type wire grid polarizer/optical film structure of the present invention. The integrated type wire grid polarizer/optical film 20 comprises a first portion and a second portion. The first portion is a wire grid reflective type polarizer/optical film 201. The second portion is an absorbing type polarizer/optical film 202 formed on the first portion. The absorbing type polarizer/optical film 202 may be an O type dye series polarizer or an E type polarizer/optical film.

The integrated type wire grid polarizer/optical film of the present invention has high polarizing efficiency, high transmittance and is able to reflect light at higher levels than the prior art. So, the present invention can not only be applied to polarizers, wide viewing angles or brightness enhancement films on LCDs, but also for polarizing optical microscopes, sunglasses, sunshade objects, display functions and lighting functions.

The integrated type wire grid polarizer/optical film structure can act as a sunshade or a heat insulation film if it is coated. The sunshade or heating insulation film can be applied as a sunshade or as heating insulation paper for a building, sunglasses, a parasol or sunshade heating insulation paper for car windows.

In another example, the integrated type wire grid polarizer/optical film structure can act as a reflective film for spun or woven goods if coated. Coating the film on spun or woven goods causes body heat to stay trapped inside the material so that clothing will provide additional warming properties for the wearer.

Furthermore, the integrated type wire grid polarizer/optical film structure reflects ultraviolet rays and can be applied to a parasol that reflects ultraviolet rays.

The present invention matches different materials to produce an infrared ray absorbent film that can be applied to clothes that deflect infrared rays. If the reflective film is coated on the outside of the clothes, they therefore provide a stealth function. This characteristic can also be used for other military purposes, such as deflective material applied to airplanes.

As another example, the integrated type wire grid polarizer/optical film structure of the present invention has an absorbent function when applied to shoe pads. The shoe pads with the reflective film make the wearer's feet feel cool. The present invention has a wire grid reflective type polarizer that uses conductive material. For example, it used a conductive heat wire that transmits power or heat.

<<Experimental Proof>>

An experimental proof is seen in a second table below. The second table shows a system module with iodine to achieve an optical value. This provides two solutions overcoming, firstly, the problem of polarizing efficiency and transmittance of double-layered film, and secondly, the integrated film compared with the prior art has a better design. The design value of the entire polarizing efficiency is 95% and transmittance is 40%. The polarizing efficiency of the first layer polarizer must be 98.34% and the transmittance must be 43.8%. The polarizing efficiency of the second layer polarizer must be 53.26% and transmittance must be 59.87%.

SECOND TABLE

| | | Novel | Novel | |
|---|---|---|---|---|
| | | polarizer 1 | polarizer 2 | |
| | Simulated | Experiment | Experiment | Best |
| | value | one | two | Simulated value |
| First layer | 98.34% | 98.369% | 99.1% | 99% |
| polarizing | | | | |
| efficiency | | | | |
| First layer | 43.8% | 43.843% | 44.49% | 44.5% |
| transmittance | | | | |
| Second layer | 53.26% | 59.4% | 86.33% | 81.89% |
| polarizing | | | | |
| efficiency | | | | |
| Second layer | 59.87% | 53.4821% | 50.83% | 54.61% |
| transmittance | | | | |
| Total | 99.5% | 99.58% | 99.93% | 99.9% |
| polarizing | | | | |
| efficiency | | | | |
| (500 nm) | | | | |
| Total | 40% | 37.58% | 41.96% | 44% |
| transmittance | | | | |

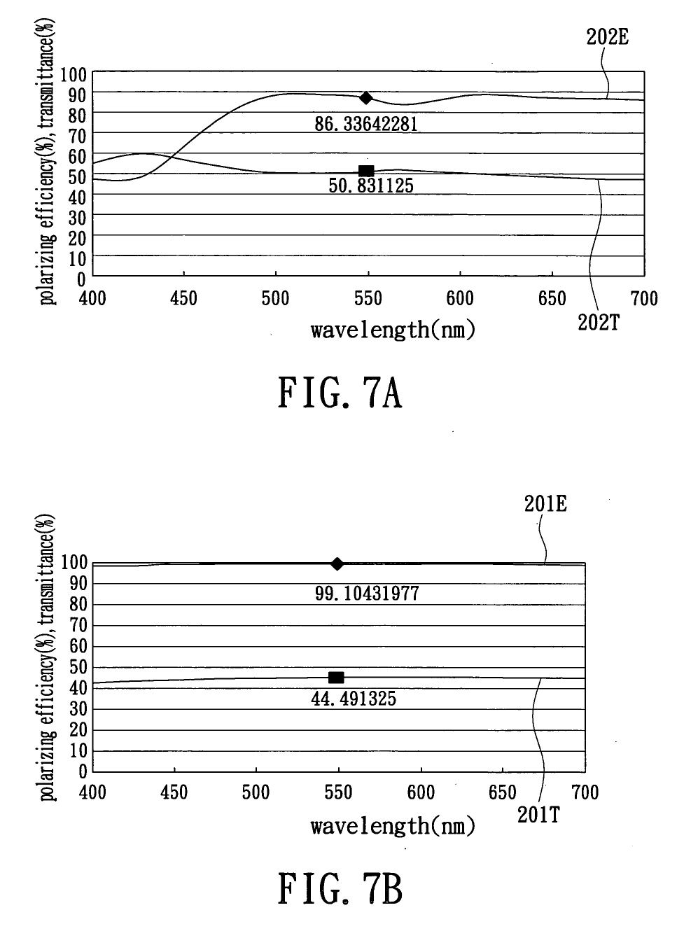

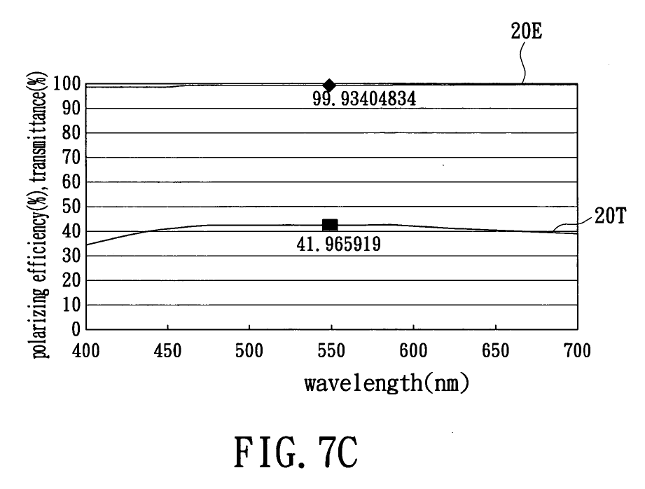

In the first segment of the experimental proof (novel polarizer, experiment one), the polarizing efficiency of the first layer polarizer/optical film is 98.369% and the transmittance is 43.843% (500 nm wavelength). The polarizing efficiency of the second layer polarizer/optical film is 59.4% and the transmittance is 53.48%. The polarizing efficiency is 99.58% and the transmittance is 37.58% after the polarizer is integrated. In the second segment of the experimental proof (novel polarizer, experiment two), the polarizing efficiency of the first layer polarizer/optical film is 99.1% and the transmittance is 44.49% (500 nm wavelength). The polarizing efficiency of the second layer polarizer/optical film is 86.33% and transmittance is 50.83%. The polarizing efficiency is 99.93% and transmittance is 41.96% after the polarizer is integrated. The result of the second test is shown in FIGS. 7A to 7C. FIG. 7A shows a polarizing efficiency curve 202E. The transmittance curve 202T is a different wavelength relative to the second layer (absorbing layer). FIG. 7B shows a polarizing efficiency curve 202E. The transmittance curve 202T is a different wavelength relative to the first layer (wire grid layer). FIG. 7C shows a polarizing efficiency curve 202E. The transmittance curve 202T is a different wavelength relative to the after integrated polarizer.

To sum up above, the results show a more accurate polarizing efficiency and transmittance when the film is close to optical theory. The result also shows that the polarizing efficiency and the transmittance distribution uses non-linear optical so the design integrates two low polarizer/optical films to a signal polarizer/optical film with simultaneously high polarization and high transmittance. The result proves that the optical distribution design not only keeps original transmittance but also achieves an increase in polarizing efficiency. The brightness enhancement film matches polarizing efficiency (86.33%) and transmittance (50.83%) low polarizer after optical design and calculation. The combination of whole polarizing efficiency and the transmittance is the same as the conventional polarizer. The wire grid polarizer thickness is about a nanometer. The thickness of the wire grid polarizer is about one per hundred to the iodine polarizer. The present invention is produced on the LCD and has the advantage of high heat resistance. Compared with the normal iodine polarizer, the polarizer of the present invention is reflective and increases reflective brightness.

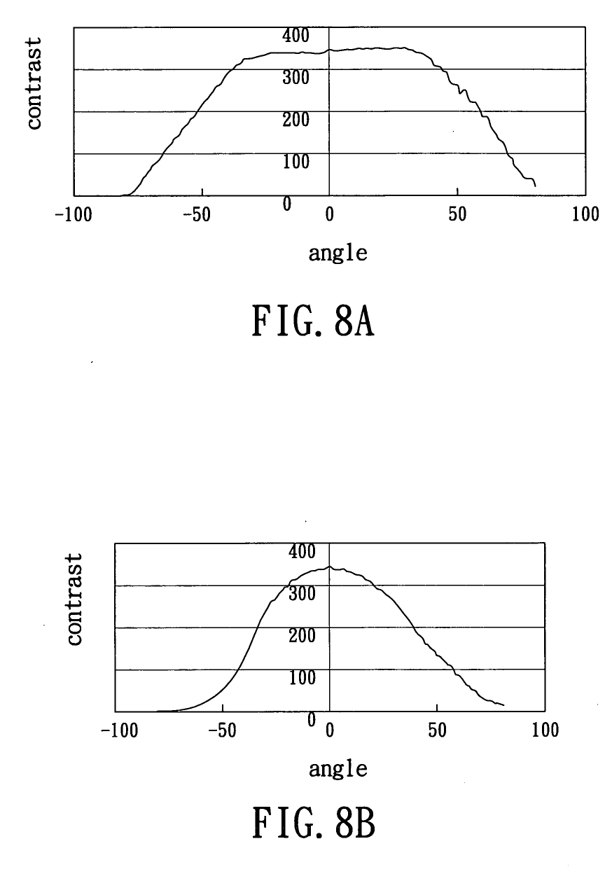

FIG. 8A show a cross-section drawing of the transmittance rate of the integrated type polarizer at a 45-degree angle. FIG. 8B shows a cross-section drawing of the transmittance rate of the integrated type polarizer at a 315-degree angle. Compared with the normal polarizer, the integrated type polarizer of the present invention has a wide viewing angle and high transmittance, except when it has the same polarizing efficiency or an improved polarizing efficiency over the normal polarizer. The integrated type polarizer of the present invention also has simultaneously enhanced reflective brightness and a wide viewing angle.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A manufacturing method of an integrated polarizer/optical film with a wire grid structure, comprising the following steps:
providing at least one substrate;
forming a wire grid reflective type polarizer on the substrate as a first portion of the integrated polarizer/optical film; and
forming an absorbing type polarizer that is a second portion of the integrated polarizer/optical film, wherein the second portion is pasted on the first portion using a non-linear optically manner to integrate with the first portion, wherein the absorbing type polarizer is an O type dye polarizer or an E type polarizer.

2. The manufacturing method as claimed in claim 1, wherein said reflective type polarizer is constructed inside or outside said display cell.

3. The manufacturing method as claimed in claim 1, wherein said absorbing polarizer is constructed inside or outside said display cell.

4. The manufacturing method as claimed in claim 3, wherein said absorbing polarizer is constructed inside said display cell via a coating manner.

5. The manufacturing method as claimed in claim 1, wherein said absorbing polarizer is coated outside said display cell and is attached to said reflective type polarizer.

6. The manufacturing method as claimed in claim 1, wherein said absorbing polarizer is coated on said reflective type polarizer and is attached to said display cell.

7. The manufacturing method as claimed in claim 1, wherein if said integrated polarizer/optical film is constructed outside said display cell, said absorbing type polarizer is a dye series polarizer or an E type polarizer.

8. The manufacturing method as claimed in claim 7, wherein said absorbing type polarizer is coated on an outside of said display cell and is attached to said reflective type polarizer.

9. The manufacturing method as claimed in claim 7, wherein said absorbing type polarizer is coated on said reflective type polarizer and is attached to said display cell.

10. The manufacturing method as claimed in claim 1, wherein a multi-layered film is disposed between said substrate and said reflective type polarizer or said absorbing type polarizer.

11. The manufacturing method as claimed in claim 1, wherein said substrate is a transmission substrate or a non-transmission substrate.

12. The manufacturing method as claimed in claim 11, wherein said substrate is comprised of polymers.

13. The manufacturing method as claimed in claim 1, wherein the step of coating is achieved via a slot-die coating method, an extrusion coating method, a Mayer rod coating method and a blade coating method.

14. The manufacturing method as claimed in claim 1, wherein said integrated polarizer/optical film is used as a polarizer for a display, a brightness-enhancing film, a wide-viewing angle film or a general optical film.

15. A manufacturing method of an integrated polarizer/optical film with a wire grid structure, comprising the following steps:
providing at least one substrate;
forming a wire grid reflective type polarizer on one side of the substrate as a first portion of the integrated polarizer/optical film; and
forming an absorbing type polarizer that is a second portion of the integrated polarizer/optical film, wherein the second portion sits upon another side facing the substrate using a non-linear optically manner to integrate with the first portion.

16. The manufacturing method as claimed in claim 15, wherein said absorbing type polarizer is an O type dye polarizer or an E type polarizer.

17. The manufacturing method as claimed in claim 15, wherein said wire grid reflective type polarizer is constructed inside or outside said display cell.

18. The manufacturing method as claimed in claim 15, wherein said absorbing polarizer is constructed inside or outside said display cell.

19. The manufacturing method as claimed in claim 15, wherein said absorbing polarizer is coated on said reflective type polarizer and is attached to said wire grid reflective type polarizer.

20. The manufacturing method as claimed in claim 15, wherein said absorbing polarizer is coated on said reflective type polarizer and is attached to said display cell.

21. The manufacturing method as claimed in claim 15, wherein if said integrated polarizer/optical film is constructed outside said display cell, said absorbing type polarizer is a dye series polarizer or an E type polarizer.

22. The manufacturing method as claimed in claim 15, wherein said absorbing type polarizer is coated on an outside of said display cell and is attached to said wire grid reflective type polarizer.

23. The manufacturing method as claimed in claim 15, wherein said absorbing type polarizer is coated on said reflective type polarizer and is attached to said display cell.

24. The manufacturing method as claimed in claim 15, wherein a multi-layered film is disposed between said substrate and said reflective type polarizer or said absorbing type polarizer.

25. The manufacturing method as claimed in claim 15, wherein said substrate is a transmission substrate or a non-transmission substrate.

26. The manufacturing method as claimed in claim 25, wherein said substrate is comprised of polymers.

27. The manufacturing method as claimed in claim 15, wherein the step of coating is achieved via a slot-die coating method, an extrusion coating method, a Mayer rod coating method or a blade coating method.

28. The manufacturing method as claimed in claim 15, wherein said integrated polarizer/optical film is used as a polarizer for a display, a brightness-enhancing film, a wide-viewing angle film or a general optical film.

29. A manufacturing method of an integrated polarizer/optical film with a wire grid structure, comprising the following steps:
providing a wire grid reflective type polarizer; and
providing an absorbing type polarizer attached to the wire grid reflective type polarizer and using a non-linear optically manner to integrate with thereof, wherein the absorbing type polarizer is an O type dye series polarizer or an E type polarizer.

30. The manufacturing method as claimed in claim 29, wherein said wire grid reflective type polarizer is constructed inside or outside said display cell.

31. The manufacturing method as claimed in claim 29, wherein said absorbing polarizer is constructed inside or outside said display cell.

32. The manufacturing method as claimed in claim 29, wherein said absorbing polarizer is coated on said reflective type polarizer and is attached to said wire grid reflective type polarizer.

33. The manufacturing method as claimed in claim 29, wherein said absorbing type polarizer is coated on said wire grid reflective type polarizer and is attached to said display cell.

34. The manufacturing method as claimed in claim 29, wherein a multi-layered film is disposed between said wire grid reflective type polarizer and said absorbing type polarizer.

35. The manufacturing method as claimed in claim 29, where said integrated polarizer/optical film is formed on at least one substrate, said substrate is a transmission substrate or a non-transmission substrate.

36. The manufacturing method as claimed in claim 35, wherein said substrate is composed of polymers.

37. The manufacturing method as claimed in claim 29, wherein the step of coating is achieved via a slot-die coating method, an extrusion coating method, a Mayer rod coating method, or a blade coating method.

38. The manufacturing method as claimed in claim 29, wherein said integrated polarizer/optical film is used as a polarizer for a display, a brightness-enhancing film, a wide-viewing angle film or a general optical film.

39. An integrated polarizer/optical film, comprising:
A first portion that is a wire grid reflective type polarizer; and
A second portion that is an absorption type polarizer using a non-linear optically manner to integrate with the first portion, wherein the absorbing type polarizer is an O type dye series polarizer or an E type polarizer.

40. An integrated polarizer/optical film structure, comprising:
at least one substrate; and
at least one layered integrated polarizer/optical film sitting on any side of the substrate, wherein the integrated polarizer/optical film comprises two portions: a wire grid reflective type polarizer that is a first portion and an absorption type polarizer that is a second portion to integrate with the first portion, wherein the absorbing type polarizer is an O type dye series polarizer or an E type polarizer.

41. The structure as claimed in claim 40, further comprises a conductive layer sitting on the substrate, said absorbing type polarizer or said reflective type polarizer.

42. The structure as claimed in claim 40, wherein said reflective type polarizer sits on an inside or an outside of said display cell.

43. The structure as claimed in claim 40, wherein said absorbing type polarizer sits on an inside or an outside of said display cell.

44. The structure as claimed in claim 40, wherein said absorbing type polarizer sits on an outside of said display cell and is attached to said reflective type polarizer.

45. The structure as claimed in claim 40, wherein said absorbing type polarizer is coated on said reflective type polarizer and is attached to said display cell.

46. The structure as claimed in claim 40, wherein said integrated polarizer/optical film structure is used as a polarizer for a display, a brightness-enhancing film, a wide-viewing angle film or a general optical film.

47. The structure as claimed in claim 40, wherein said integrated polarizer/optical film structure is applied to products that function as a sunshade or a heat insulator.

48. The structure as claimed in claim 40, wherein said integrated polarizer/optical film structure is used for human products.

49. The structure as claimed in claim 40, wherein said integrated polarizer/optical film structure is used for military purposes.

50. An integrated polarizer/optical film structure, comprising:
at least one substrate; and
at least a two-layered integrated polarizer/optical film, one of said layers sits on any side of the substrate and the other layer sits on an other side of the substrate, wherein the integrated polarizer/optical films comprises two portions, a first portion is a wire grid reflective type polarizer and a second portion is an absorbing type polarizer to integrate with thereof.

51. The structure as claimed in claim 50, wherein said absorbing type polarizer is an O type dye series polarizer or an E type polarizer.

52. The structure as claimed in claim 50, wherein said substrate is a transmission substrate or a non-transmission substrate.

53. The structure as claimed in claim 50, further comprises a conductive layer sitting on the substrate, said absorbing type polarizer or the reflective type polarizer.

54. The structure as claimed in claim 50, wherein said reflective type polarizer sits on an inside or an outside of said display cell.

55. The structure as claimed in claim 50, wherein said absorbing type polarizer sits on an inside or an outside of said display cell.

56. The structure as claimed in claim 50, wherein said absorbing type polarizer sits on outside of said display cell and is attached to said reflective type polarizer.

57. The structure as claimed in claim 50, wherein said absorbing type polarizer is coated on said reflective type polarizer and is attached to said display cell.

58. The structure as claimed in claim 50, wherein said integrated polarizer/optical film structure is used as a polarizer for a display, a brightness-enhancing film, a wide-viewing angle film or a general optical film.

59. A display unit with an integrated polarizer/optical film structure, comprising:
a first substrate and a second substrate;
at least one layered integrated polarizer/optical film sitting on the any side of the first substrate or the second substrate, wherein the integrated polarizer/optical films includes twp portions, a first portion that is a wire grid reflective type polarizer and a second portion that is an absorbing type polarizer, wherein the second portion is integrated with the first portion; and
a plurality of display fluid media filled between the first substrate and the second substrate.

60. The display unit as claimed in claim 59, wherein said absorbing type polarizer is an O type dye series polarizer or an E type polarizer.

61. The display unit as claimed in claim 59, wherein said first substrate and said second substrate are transmission substrates or non-transmission substrates.

62. The display unit as claimed in claim 59, wherein said integrated polarizer/optical film sits on an outside of said display cell, said absorbing type polarizer is a dye series or an E type and the reflective type polarizer is a wire grid reflective type polarizer.

63. The display unit as claimed in claim 59, wherein said reflective type polarizer sits on an inside or an outside of said display cell.

64. The display unit as claimed in claim 59, wherein said absorbing type polarizer sits on an inside or an outside of said display cell.

65. The display unit as claimed in claim 59, wherein said absorbing type polarizer sits on an outside of said display cell and is attached to said reflective type polarizer.

66. The display unit as claimed in claim 59, wherein said absorbing type polarizer is coated on said reflective type polarizer and is attached to said display cell.

67. The display unit as claimed in claim 59, wherein said display fluid medium is a liquid crystal, an electrophoresis, a self-luminous object or another fluid medium for easy display.

68. The display unit as claimed in claim 59, wherein one of said integrated polarizer/optical films with wire grid wire grids is divided into two portions and sits on two sides of said first substrate and said second substrate individually, wherein the two portions are interlocked.
